(19) United States
(12) Patent Application Publication
(10) Pub. No.: US 2026/0073366 A1
(43) Pub. Date: Mar. 12, 2026

(54) UNIFICATION TYPE DATA STRUCTURE GUARANTEEING MONOTONICITY AND CRYPTOCURRENCY SYSTEM USING THE SAME

(71) Applicant: Cognitive Research Labs, Inc., Tokyo (JP)

(72) Inventor: Hideto TOMABECHI, Tokyo (JP)

(21) Appl. No.: 19/390,751

(22) Filed: Nov. 17, 2025

Related U.S. Application Data
(63) Continuation-in-part of application No. 18/241,924, filed on Sep. 4, 2023, now abandoned.

(30) Foreign Application Priority Data
Nov. 2, 2022 (JP) 2022-176461

(51) Int. Cl. G06Q 20/06; G06F 16/22

(52) U.S. Cl. CPC G06Q 20/065; G06F 16/2246

(57) ABSTRACT

A cryptocurrency system includes a first server including a first controller, a first communication unit, and a first non-transitory storage medium; and a second server including a second controller, a second communication unit, and a second non-transitory storage medium, wherein the second controller includes a unification unit carrying out unification process, the first controller generates cryptocurrency comprised of tree-structured data, the second controller, when the second server receives the cryptocurrency from the first server, makes a temporary tree-structure of cryptocurrency candidate to be received from the first sever, the unification unit carries out the unification process to compare an attribute of the cryptocurrency to an attribute of the candidate cryptocurrency, and the unification unit generates a new tree-structure only when both of the attributes logically match each other.

### CROSS-REFERENCE TO RELATED APPLICATION

The present application is a continuation-in-part application of U.S. patent application Ser. No. 18/241,924 filed on Sep. 4, 2023, which claims priority to Japanese Patent Application No. 2022-176461 filed on Nov. 2, 2022. The disclosures of these applications are incorporated by reference.

### BACKGROUND OF THE INVENTION

### Field of the Invention

The invention relates to a unification type data structure capable of guaranteeing monotonicity, and further to a cryptocurrency system making use of the same.

### Description of the Related Art

In financial systems and national-level information processing infrastructures, it is not a goal merely to “store” data. What is important is that stored data remains unaltered, free from contradictions, and persists over time while maintaining semantic continuity.

Data serves as a foundation for demonstrating a basis of value across time and guiding future decisions. What is required in data preservation algorithms is not “volume,” but “reliability.” In other words, the key issue is not how much information can be accumulated, but how accurately, consistently, and durably information can be retained over time. Four perspectives supporting the reliability are presented hereinbelow.

### (1) Monotonicity

Monotonicity means a structure in which data can only “increase.”

The first and most fundamental principle of data preservation is that “recording of data must be irreversible.” That is, once information is saved, it cannot be erased through overwriting or deletion. New information is always layered on top of existing information in the form of an “addition.” This structure is called monotonicity, in which data may increase, but never decrease.

In an information system endowed with monotonicity, the entire history functions as continuous temporal evidence. Since structural modification or deletion is structurally impossible, reliability of records is inherently guaranteed. This “append-only” design philosophy is a fundamental requirement for achieving both authenticity and irreversible immutability of information.

### (2) Consistency

Consistency indicates a storage structure that does not accept inconsistencies between pieces of data.

The second principle of data storage is logical consistency as a whole. Consistency indicates a property that ensures newly stored information does not contradict existing information. This implies a structure where consistency is verified at a moment of data storage, rather than detecting contradictions afterwards.

In an ideal data storage system, storage and validation are integrated, and thus, information that contains contradictions is not accepted. Such a structure eliminates a need for error correction through post-processing and maintains a logically consistent system from the outset.

In other words, consistency is not a condition for “accurately storing data”, but a condition for “preventing incorrect data from being stored”.

### (3) Causal Consistency

Causal consistency means a structure that preserves a semantic order of events.

The third principle is the preservation of causal order relationships among data.

Data does not exist in isolation, but always derives its meaning through its relationships with other data. Consequently, it is necessary to correctly maintain a causal chain, that is, which data is based on which event, and which data arose as its consequence.

If this principle is violated, even if each individual piece of data is accurate, the system as a whole may produce incorrect interpretations or contradictions.

For example, if a money transfer is processed before verifying that an account balance is sufficient, the logical causal relationship collapses, and hence, the system can no longer be considered coherent.

Causal consistency is thus a property that guarantees both a temporal order and a semantic dependencies of information. Causal consistency serves as a fundamental structure that enables an information system to function as a “chronological narrative of truth”.

### (4) Computational Efficiency

The fourth principle is practical computability.

No matter how strictly a system upholds monotonicity and consistency, if verifying or maintaining them requires excessive computational resources or time, it cannot function as a practical social system.

The reliability of information preservation rests not only on theoretical correctness but also on temporal sustainability. In other words, a series of processes such as registration, verification and reconciliation of information should operate without causing computational explosion relative to a number of inputs. It is desirable that the system works with a roughly linear workload.

Only when the condition is satisfied, a practical information infrastructure which balances trust and immediacy can be realized. Thus, computational efficiency is a requirement for sustaining reliability at a viable operational speed.

These four perspectives, that is, monotonicity, consistency, causal coherence and computational efficiency, are not independent elements from one another, but mutually complementary structural principles. Monotonicity supports the irreversibility of records; consistency ensures the elimination of systemic contradictions; causal coherence guarantees the semantic order of events; and computational efficiency provides the speed necessary to sustain them in reality.

When those four elements are simultaneously fulfilled, the information system attains a four-layered stable structure, which is tamper-proof, contradiction-free, semantically coherent, and non-stopping. Such a system represents an ideal condition for high-trust information infrastructures for finance, government, and social foundations.

### [Risks of Blockchain]

Currently, cryptocurrencies such as Bitcoin are traded through blockchain technology.

A blockchain has a structure that seeks to ensure legitimacy through elimination of centralized trust and distributed consensus.

However, within the blockchain system, the above-mentioned fundamental principles such as monotonicity, consistency, causality, and computational efficiency cannot simultaneously hold, resulting in an inherent logical contradiction that leads to self-destruction. This contradiction is explained hereinbelow.

Blockchain is not a mechanism that prevents tampering, but a mechanism that detects tampering. In other words, once incorrect information is recorded, it is not removed but preserved as is. Although post-processing may eliminate false data, integrity of data is not guaranteed at the time of recording data.

In particular, a structure that relies solely on post correction to ensure historical consistency fundamentally undermines the coherence of a recording system. Moreover, simplifications and caching implemented to maintain a processing speed further accelerate degradation of consistency.

The suitability of blockchain as an information storage algorithm is examined hereinbelow.

### (1) Evaluation of Monotonicity

Formally, blockchain is described as a system in which “past blocks cannot be tampered”, but this is true only in a limited sense.

True monotonicity indicates a structural guarantee that past data will not be modified, deleted, or dereferenced if new data are added thereto.

However, in the blockchain system, if collusion or coordinated manipulation occurs among miners responsible for consensus formation, it is technically possible to reconstruct or delete past blocks, resulting in that immutability of history can structurally collapse.

Thus, though the blockchain may appear to be an append-only system, in practice, past records are constantly subject to recalculation and revalidation, meaning that true monotonicity is not maintained.

In fact, in the blockchain hacking incident having happened in Israel, certain forest structures were deleted, and all transaction data within those intervals were lost. This indicates that historical records are not continuously preserved and that connections between blocks can be partially severed. Once a part of forest disappears, the relational consistency before and after the part becomes untraceable, rendering even post-facto verification impossible.

### (2) Evaluation of Consistency

The blockchain records transaction histories, but fails to have a systematic algorithm for verifying legality of each transaction.

Theoretically, each sender and receiver could maintain consistency by verifying the entire history of transmission and reception at a computational cost of O(log N)×2×2. In practice, however, such verification is often omitted.

Consequently, if the sender, receiver or exchange colludes, fraudulent entries can go undetected. As a result, though the blockchain defines the requirement of consistency at a theoretical level, it fails to guarantee the requirement in implementation.

### (3) Evaluation of Causal Consistency

Since history of the blockchain is linear and each transaction is treated independent from one another, it is impossible to reconstruct overall causal relationships.

For instance, an address might falsely represent itself as another entity or appear to have received money from a non-existent sender, resulting in that a false causal chain may be fabricated.

Forking or caching that detaches portions of a past structure effectively constitutes a “discontinuity of records.” This disrupts causal coherence between past and present, making it impossible to detect fraudulent transactions.

### (4) Evaluation of Computational Efficiency

In the blockchain system, it is necessary to recursively refer to the past entire transaction history with O(log N) each time when the validity of a transaction is verified.

If the theoretical verification were fully performed, the growing value of N would lead to computational explosion, making real-time processing impractical, resulting in widespread reliance on off-chain or cached shortcut processing.

Consequently, the blockchain system cannot avoid a structural trade-off between consistency and a computation speed, leaving foundation of reliability merely formal rather than substantive.

Furthermore, when a balance of a sender A is verified, it is also necessary to recursively verify balances of preceding senders B and C. As a result, theoretical computational complexity of O(log N) stacks hierarchically, producing in practice an accumulated load of O(log N×log N×log N . . . ). This recursive structure exponentially increases computational burden as a transaction history grows, resulting in that scalability is fundamentally hindered.

As described above, although the blockchain aspires in principle to provide “tamper-proof records,” it is in fact burdened with inherent structural contradictions.

The lack of monotonicity breaks continuity of history, and the lack of consistency erases trust. The absence of causal consistency disrupts an order of meaning, and the lack of computational efficiency renders all of these impossible to practically sustain.

Consequently, the blockchain is merely a “collection of tamper-resistant fragments”, rather than a “coherently trustworthy system as a whole”. To transcend this structural limitation, it is necessary not to redesign a form of records, but to reconstruct a logic by which records are generated.

### SUMMARY OF THE INVENTION

In view of the above-mentioned defects of the blockchain, it is an exemplary object of the present invention to provide a cryptocurrency system capable of transmitting/receiving cryptocurrency without using the blockchain, and further, capable of correcting the defects of the blockchain.

In particular, it is further an exemplary object of the present invention to provide a cryptocurrency system capable of readily realizing UBI (Universal Basic Income).

In order to solve the defects of the blockchain, the inventor newly developed an algorithm. This algorithm includes a unification process as a core. In this specification, the algorithm is hereinbelow called algorithm T.

### [Unification]

The major problem of the blockchain lies in the fact that information consistency can be verified only after data was recorded.

In contrast, algorithm T adopts a structure that verifies consistency at the very moment data is stored. The theoretical foundation of this structure is the concept of unification in logic.

Unification is a procedure for comparing logical consistency between different informational structures and determining whether they have a common semantic interpretation. In other words, it is an algorithmic operation that structurally examines whether “different expressions have the same meaning”.

The role of Unification in information processing is not mere comparison, but rather selection where unification integrates only relationships that can guarantee logical identity. Through this mechanism, contradictions are not corrected retroactively; instead, information that fails to match with existing information is rejected from the outset.

The basic structure of unification is explained hereinbelow.

Unification is a process that achieves “integration” by appropriately substituting variables in logical formulas to thereby match different structures with each other. During this process, labels (such as terms or predicates) and connection relations within the expressions are compared. If they align with each other, the result is “True”, and if they conflict with each other, the result is “Fail”.

FIG. 1 illustrates an example of unification.

As shown in FIG. 1(A), in two tree structures, the left tree structure refers to elements A and B through arcs labeled arc (x, y) respectively, while the right tree structure refers to element C through an arc labeled z different from arc (x, y). If these two tree structures share the identical connection relationship, unification succeeds, that is, the judgment is True, and the data is stored.

That is, if the relationships between nodes (x, y, z) are logically consistent and non-contradictory, integration is successfully accomplished.

In contrast, in the two tree structures illustrated in FIG. 1(B), the arc x in the right tree structure points to element D, resulting in a logical inconsistency with the existing structure (A, B). Specifically, arc x points to element A in the left tree structure, but to element D in the right tree structure, resulting in a mutual contradiction.

As a result, unification fails with the judgment being Fail, and thus, the data is not stored.

In this way, unification determines the consistency between pieces of information not at a symbolic level, but at a structural level. Accordingly, it goes beyond mere equivalence checking, and it is possible to automatically assess the isomorphism of logical relations. This constitutes a minimal yet sufficient logical mechanism for formally guaranteeing the consistency of stored data.

The concept of unification can be extended beyond logical computation to serve as a core operation of an information storage algorithm. In algorithm T, the unification procedure is applied at a moment of information storage, and thus, record consistency is autonomously guaranteed without relying on post hoc verification.

In other words, integration (and thus storage) occurs only when new information is consistent with an existing information system, and information that contradicts the existing information is not integrated. This structure can make “storage” and “verification” inseparable to thereby principally establish monotonicity and consistency of an entire information system.

### [Operation of Algorithm T]

Algorithm T is a logically designed information-processing structure that can store data only in a consistent form. A core of algorithm T is the dynamic application of the above-mentioned unification procedure under the constraint that “information storage occurs only when new information can be integrated into an existing information system”. This mechanism ensures that storage and verification function as an indivisible operation, and thus, monotonicity, consistency and causality of data is automatically guaranteed.

In algorithm T, information is represented as a labeled cyclic/acyclic directed graph. Each node is assigned attribute labels such as address (destination), amount and for (purpose), and directed links between nodes express dependencies among information. Unification process logically compares connection relations among these labels. If they are consistent with each other, old and new data are integrated, and if they are contradictory with each other, new data is discarded.

Thus, while each unit of information may appear tree-structured, the overall system unfolds as a non-cyclic (acyclic) logical consistency network.

### [Examples of Unification Process]

Examples of actual coin (cryptocurrency) transfer are shown hereinbelow.

One of the features of algorithm T is that time information (a timestamp) is embedded in each node. This embedded timestamp ensures that the result of unification is uniquely determined in chronological order, guaranteeing causal continuity.

FIG. 2 is a schematic view illustrating the process of coin transfer via unification in algorithm T, and FIG. 3 is a flowchart of the process.

The “coin” shown in the examples is not a mere “transaction record” found in a blockchain, but the coin itself exists as a tree-structured data entity with attributes.

In the following examples, first through third servers are each equipped with a communication device for communicating with other servers, a non-transitory storage medium for storing coins therein, and a controller for managing the operation of the server. The controller in each of the first to third servers is designed to include a unification processing unit that executes unification.

As illustrated in FIG. 2, the first server generates and issues coin 200 [Coin-i] (step S110 in FIG. 3).

Coin 200 has a tree structure with the following attributes, add-0 (address) addressed to the first server, an amount 100, and “unrestricted [ ]” as “for (usage)”.

At the present stage, coin 200 belongs to an issuing node of the first server, and is not yet integrated with other coins. Coin 200 possesses a unique identifier (Coin-i), which enables consistent tracking throughout the entire algorithm T. To indicate the initial time, the coin structure of coin 200 is denoted as Coin-i (t=0).

It is now supposed that coin 200 is transferred (assigned) from the first server to the second server (step S120 in FIG. 3).

When the second server requests the first server to transfer coin 200 thereto, the controller of the second server generates a temporary tree structure 210 (see FIG. 2) in the wallet (the non-transitory storage medium) to hold therein a candidate for receipt (step S130 in FIG. 3).

The tentative tree structure 210 is not yet integrated with existing data. The controller of the second server executes the unification process (step S140 in FIG. 3) to compare the coin structure of coin 200 Coin-i (t=0) with the tentative tree structure 210 (step S150 in FIG. 3).

If the attributes (add, amount, for) of both of the tree structures are logically consistent with each other (YES in step S150 in FIG. 3), unification succeeds, and the controller generates a new tree structure 220 Coin-i (t=1) (step S160 in FIG. 3).

Upon the generation of the new tree structure 220 Coin-i (t=1), both the tentative tree structure 210 stored in the second server's wallet and the old tree structure 200 Coin-i (t=0) become dereferenced, leaving only the new tree structure 220 Coin-i (t=1) in existence in the wallet of the second server.

Thus, the transfer of coin 200 from the first server to the second server is completed.

The time at which the new tree structure 220 was generated is recorded as Unification Time 1 (step S170 in FIG. 3), and thereafter, only the new tree structure 220 is recognized as the valid coin Coin-i within the system.

If the attributes (add, amount, for) of both of the tree structures are not logically consistent with each other, that is, contradictions exist between the attributes (NO in step S150 in FIG. 3), unification is not successful, and no new tree structure is generated (step S180 in FIG. 3).

In other words, since the transaction data lacks consistency, the transaction (transfer or assignment) itself fails, and thus, no new tree structure is stored. The tree structure of coin 200 Coin-i (t=0) is deleted in need.

Next, it is supposed that coin 220 is transferred (assigned) from the second server to the third server (step S190 in FIG. 3).

FIG. 4 is a schematic view illustrating the coin transfer process, similarly to FIG. 2.

In the coin transfer to the third server from the second server, the transfer process is fundamentally the same as the transfer of coin 200 from the first server to the second server.

When the coin 220 coin-i is transferred to the third server from the second server, the coin only valid is the latest tree structure 220 coin-i (t=1), since the old tree structure 200 Coin-i (t=0) has already been dereferenced.

On transmission of a transfer request for coin 220 to the second server (step S190 in FIG. 3), the controller of the third server generates a tentative tree structure 230 (see FIG. 4) in the wallet of the third server to serve as a candidate for receipt (step S200 in FIG. 3).

As shown in FIG. 4, the tentative tree structure 230 defines the address information of the recipient third server (add-2=the third server) and the usage condition (for=[ ] (unrestricted)), but remains inconsistent at this point.

The controller of the third server executes the unification process (step S210 in FIG. 3) to compare the coin 220 Coin-i (t=1) with the tentative tree structure 230 stored in the wallet of the third server (step S220 in FIG. 3).

If the attributes (add, amount, for) of both of the tree structures are logically consistent with each other (YES in step S220 in FIG. 3), unification succeeds, and thus, the controller generates a new tree structure 240 Coin-i (t=2) (step S230 in FIG. 3).

Upon the generation of the new tree structure 240 Coin-i (t=2), both the tentative tree structure 230 stored in the third server's wallet and the old tree structure 220 Coin-i (t=1) are dereferenced, leaving only the new structure 240 Coin-i (t=2) in existence in the wallet of the third server.

Thus, the transfer of the coin to the third server from the second server is completed.

The time at which the new tree structure 240 was generated is recorded as Unification Time 2 (step S240 in FIG. 3), and the usage attribute (for) is inherited by the new tree structure 240 Coin-i (t=2).

Thereafter, only the new tree structure 240 is recognized as the valid coin Coin-i within the system.

If the attributes (add, amount, for) of both of the tree structures are not logically consistent with each other, that is, contradictions exist between the attributes (NO in step S220 in FIG. 3), unification fails, and thus, no new tree structure is generated (step S250 in FIG. 3). In other words, since the transaction data lacks consistency, it is not stored in the tree structure. That is, the transaction (transfer) itself fails.

One of the key features of the unification process in algorithm T is that no data copying is performed, but the structure is updated only through pointer (reference) manipulation. In general databases or blockchains, a new state is created by copying existing data each time, and states are stacked as a history. As a result, data volume and computational load for consistency verification tend to increase exponentially.

In contrast, in algorithm T, when unification succeeds, the pointer reference to the old tree structure is simply released (dereferenced) and a pointer to the new tree structure is generated, and thus, the actual data body is not reconstructed. Thus, although a new coin Coin-i (t+1) logically appears to be generated, the existing data is lightly updated physically without memory reallocation.

Algorithm T provides the following effects advantages.
(A) Minimizes data processing overhead.
(B) Significantly improves processing speed.
(C) Structurally eliminates “redundancy through copying” and “contradictions in history”.

In other words, unification is an operation that, while generating a “new structure,” maintains logical consistency without duplicating data, but only with the switching of references.

### [Addition of Constraints]

Another feature of algorithm T is that a constraint can be directly embedded into a tree structure of coin.

A representative example is a usage constraint (“for”), which allows logical definition of a purpose or a scope of use for a coin. For instance, if the use of a coin is to be restricted solely to environmental expenditures, the coin's usage constraint is defined as “for=green”. In this way, social conditions can be embedded into a coin as a part of coin's information structure.

The usage constraint (for) is a monotonically strengthening attribute, that is, a transition from “for=[ ]” (unconstrained) to “for=green” is permitted, but the reverse (relaxing) transition, that is a transition from “for=green” to “for=[ ]” makes unification invalid.

FIGS. 5, 6 and 7 are schematic diagrams showing examples of the unification process involving the addition of constraints.

In the example shown in FIG. 5, a coin 250 issued by the first server (the issuing authority) has a usage constraint of “for=green” (usable only for environmental purposes). A provisional tree structure 260 generated in the wallet of the second server to which the coin 250 is to be transferred is also defined with the same condition “for=green”.

Since both of the attributes match perfectly with each other, unification succeeds, and thus, a new tree structure 265 Coin-i (t=1) is generated.

The coin 265 can be used afterwards exclusively for “environment-related purposes”.

In the example shown in FIG. 6, the coin 250 issued by the first server also has the constraint “for=green”, but a provisional tree structure 270 generated in the second server's wallet is defined with no constraints (for=[ ]).

In this example, unification also succeeds, and thus, a new tree structure 275 Coin-i (t=1) is generated in the wallet of the second server.

However, the restriction “for environmental use only” is inherited in subsequent transfers or uses.

In the example shown in FIG. 7, a provisional tree structure 280 generated in the wallet of the second server to which coin 250 is to be transferred is defined with the usage constraint “for=fuel” (usable only for fuel purposes).

Since there is a logical contradiction between the constraint “for=green” attached to coin 250 and the constraint “for=fuel” in the second server's provisional tree structure 280, unification fails, and thus, no integrated tree structure is generated. As a result, the transaction data is not stored, and the transfer of coin 250 to the second server does not occur.

As having been explained above, in algorithm T, unification is established only when all attributes associated with a coin are logically consistent, and transactions containing contradictions between attributes are structurally eliminated. Thus, algorithm T constitutes an informational framework that automatically ensures reliability, ethical validity and policy compliance within the algorithm itself.

In contrast, the blockchain merely records data transactions and, unlike algorithm T, cannot specify intended purpose of use.

### [Chronological Consistency Through Timestamps]

Algorithm T can employ two types of timestamps to guarantee the temporal consistency of a coin-tree structure.

Specifically, the two types of timestamps are “a logical time internally recorded when a unification is established” and “an external real-time record (global time) periodically added to a coin-tree structure. The former corresponds to an Invisible timestamp, and the latter to a visible timestamp.

The invisible timestamp is an internal metadata item automatically assigned within the system at the moment a unification process is completed.

The invisible timestamp is not output externally; and serves as a logical criterion for determining a generation order of coin-tree structures and for selecting a legitimate structure when multiple unification candidates conflict with one another. Since a state of each coin is updated monotonically based on the internal time, the entire information system remains acyclic.

Thus, the invisible timestamp embeds the flow of time itself into the algorithm, and thus, fundamentally prevents discontinuities and inconsistencies in history, which are problems having been long plagued in the blockchain.

The visible timestamp is real-time information (global time) added as an attribute to each coin-tree structure.

The visible timestamp is periodically distributed (for example, every 24 hours) from a single global reference clock, and is written into each coin-tree structure as a “timestamp” arc.

In order to prevent fraudulent manipulation of time such as changing a device's local clock, the record cannot be overwritten, but can only be appended.

Furthermore, the time data accumulated over a certain period of time is collectively hashed and stored as a continuous temporal trace.

Through this mechanism, each coin is managed as an information entity alive within flow of time, and the chronological sequence itself functions as a part of the trust foundation to the system.

The external timestamp mechanism also serves as the basis for the “half-life currency” described later. By referencing the time data embedded in a coin-tree structure, the system can automatically decrease a coin's value (amount) according to elapsed time.

Thus, algorithm T implements the concept of a dynamic currency in which a value thereof changes as time passes. Algorithm T is not merely a recording technique for maintaining consistency; but an algorithmic structure that incorporates time itself as a component of computation.

### [Characteristics of Algorithm T]

Algorithm T is a logical information-processing structure that unifies storage, verification and consistency of data. Algorithm T overcomes the weaknesses of the widely used blockchain technology and possesses essential advantages over the blockchain.

Firstly, algorithm T automatically verifies a consistency of newly added data with existing data through the unification process at a moment new data is added, and accordingly, any information inconsistent with the existing data is not allowed to be stored.

Secondly, because verification between nodes is completed locally, the computational load remains at O(N), allowing the system to maintain a stable processing speed in proportion to the expansion of the history.

Thirdly, a basic unit of information is not a “record of transactions” as in the blockchain, but “a coin itself” in algorithm T, ensuring extensibility that enables inclusion of usage restrictions (such as “for=green”, “for=medical”).

Through the mutual interaction of these three elements, algorithm T becomes not merely a “distributed ledger”, but an informational structure enabling automatic generation of trust.

The characteristics and evaluation of algorithm T are examined hereinbelow in viewpoints of four key perspectives essential to information-preservation algorithms.

### 1. Monotonicity

According to algorithm T, whenever new information is added, unification verifies a consistency thereof with existing information with the result that any information inconsistent with existing data is not stored. This structure makes deletion or tampering of information structurally impossible, ensuring that the historical record is irreversibly cumulative. Once a node is added to the history, the node is fixed as a part of the logical consistency of the entire informational system and cannot be revoked afterward. As a result, all information is preserved as a seamless continuum of truth.

### 2. Consistency

The core principle of algorithm T lies in that consistency is guaranteed at the moment of data preservation.

The unification process verifies the logical relations among nodes to thereby reject any information that fails to maintain consistency, resulting in no need of post-processing or retrospective consistency adjustments, which is required in the blockchain systems. This mechanism allows the entire database to exist continuously in a state of logical coherence.

### 3. Causal Consistency

Each node is added by explicitly referencing its logical prerequisite nodes. Accordingly, causal relationships among events are preserved not as sequences in physical time, but as logical dependencies.

Moreover, since each node can also be assigned a timestamp, ensuring that consistency is maintained both in terms of semantic order and physical order. This design structurally eliminates causal gaps, enabling the entire system to be maintained as a semantically coherent temporal structure.

### 4. Computational Efficiency

Since algorithm T makes it possible to locally complete every storage operation, ensuring that verification costs can be constrained to a theoretical value of O(N).

The scope of the unification process is limited to target nodes under validation, and thus, it is not necessary to recursively reference to the entire historical record.

Consequently, even if a volume of dataset grows, the unification process linearly operates in proportion with a grown volume, enabling real-time storage and verification.

Furthermore, the unification process updates a structure not by copying data, but by switching references (pointers), eliminating physical reconstruction and redundant duplication. This non-copy mechanism ensures that computational load is kept near a theoretical O(N) level. High processing speed is thus achieved without compromising integrity verification.

The algorithmic structure itself guarantees coexistence of theoretical consistency and practical speed.

### [Informational Structure as Coins]

The most distinctive structural feature of algorithm T is that a unit of information is not a transaction, but a coin (informational entity) itself.

Each coin possesses an independent logical structure, and the generation, transfer and utilization are all handled consistently through unification. As a result, each coin becomes a self-consistent entity, ensuring that fraud and double issuance can be structurally eliminated.

Additionally, each coin can contain logical labels (for instance, for=green, for=education), allowing the coin to function as semantic currency usable only for specific purposes.

Such flexibility where meaning is embedded directly into the currency cannot be realized in the blockchain a structure dependent on the transaction history, and enables a controllable and extensible economy of diverse informational values.

### [Social Significance and Outlook]

Algorithm T is not a technology for managing trust, but a structure for generating trust. Algorithm T establishes social reliability through automatic generation of logical consistency without relying on central authorities or third-party verification.

The principles of algorithm T can be applied, beyond finance, to fields including administrative records, academic data, medical systems and AI learning logs, that is, fields where consistency is directly tied to social value. Moreover, through the use of purpose-restricted currencies and decentralized social infrastructures, algorithm T can serve as a foundational technology for a transparent and tamper-proof economic sphere.

In essence, algorithm T represents a core technology for realizing an “infrastructure of truth” in the information society.

### [Advantages Provided by the Invention]

Table 1 shows the comparison of algorithm T with the blockchain.

TABLE 1

| | Blockchain | Algorithm T |
|---|---|---|
| Monotonicity | Intermediate level: Although the | High level: The data structure itself |
| | chain structure of blocks makes | is composed solely of additive |
| | data-tampering difficult, the | elements, maintaining a |
| | blocks are discrete, and the | continuous history. Tamper |
| | overall continuity of the history is | resistance is embeddd at a |
| | limited. A unit of data addition is | structural level, and the entire |
| | large, and the structure is not | history remains consistently |
| | strictly monotonic. | irreversible. |
| Consistency | Intermediate level: Consistency is | High level: At a moment of data |
| | probabilistically guaranteed only | storage, consistency with existing |
| | after consensus is reached, but | data is verified in advance, |
| | data tampering can occur at the | eliminating contradictions |
| | time of block addition. The system | beforehand. Consistency is built |
| | has a structure that adjusts data | directly into the storage program |
| | afterward. | itself. |
| Causal Consistency | Low level: Due to asynchronous | High level: Each piece of |
| | processing in a distributed | information explicitly references its |
| | network, a causal order of events | prerequisite nodes upon addition, |
| | is indeterminate. The exact | structurally fixing a causal chain. |
| | sequence among simultaneously | Semantic order is guaranteed |
| | occurring events cannot be | without dependence on physical |
| | strictly maintained. | time. |
| Computational Efficiency | Low level: In verifying validity of | High level: Since consistency and |
| | each transaction, the entire past | causality verification are |
| | history is recursively referenced, | completed locally, processing load |
| | causing the computational load to | scales linearly. System |
| | increase cumulatively. If | performance remains almost |
| | consistency checks are omitted to | unaffected even as the system |
| | improve a speed, the complete | grows in scale. |
| | guarantee of consistency | |
| | becomes uncertain, resulting in a | |
| | trade-off with reliability. | |
| Addition of Constraint | Possible | Impossible |

As mentioned above, algorithm T in the present invention resolves the problems inherent in the blockchain technology.

Specifically, algorithm T guarantees monotonicity, which allows the addition of information, but prohibits deletion or alteration of information, at a level of a data structure. Unlike the conventional blockchain, which rely on “detecting past tampering through hash chains,” algorithm T determines consistency at the time of data writing, and fundamentally rejects any data that would introduce contradictions. In this respect, algorithm T possesses an essential advantage over the blockchain.

Unification determines the consistency between pieces of information not at a symbolic level but at a structural level. Consequently, rather than performing a mere comparison of equality, unification can automatically determine the isomorphism of logical relations. This constitutes the minimal and sufficient logical mechanism for formally guaranteeing consistency of stored data.

Furthermore, the concept of unification is not limited to a logical operation, but can be extended as a core process of an information-storage algorithm. In algorithm T, by applying the unification procedure at the very moment of information storage, the consistency of records is autonomously ensured without relying on post-hoc verification.

Specifically, integration (i.e., storage) is performed only when new information is consistent with existing information, while any information that conflicts with existing information is never integrated (stored), ensuring that storage and verification become inseparable, and thus, the monotonicity and consistency of the entire information system is principally established.

Furthermore, by embedding timestamp information into a coin-tree structure, the system not only guarantees causal consistency but also enables time itself to be treated as an element of value. Such a time-integrated information-storage structure can be applied, for example, to a national economic policy, thereby providing economic utility to society.

For instance, in the example shown in FIGS. 2 and 3, it is supposed that the first server represents the Bank of Japan, the central bank of Japan, while the second server represents the citizens of Japan. Each citizen periodically (monthly or weekly) receives a fixed amount of coins (cryptocurrency) from the Bank of Japan. Citizens use this cryptocurrency for living expenses and various forms of consumption, thereby invigorating real economy. The cryptocurrency issued by the first server is designed so that a quantity thereof gradually decreases over time; the reduced portion is automatically returned to the first server as tax. The cryptocurrency thus returned to the first server sustains Japan's general account. This system can formally give rise to a tax-free nation.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 illustrates an example of unification.

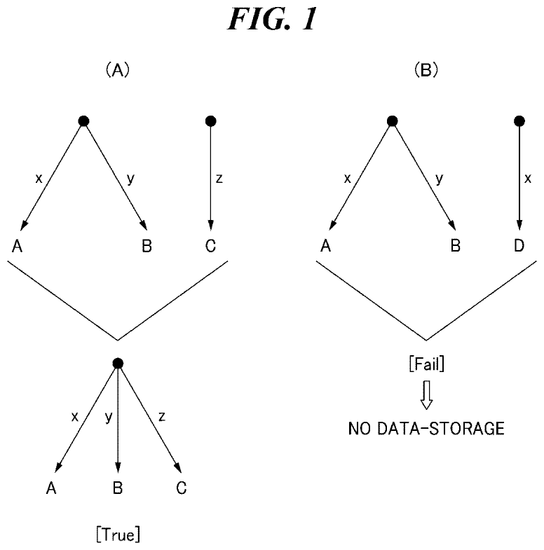

FIG. 2 is a schematic view illustrating the process of coin transfer via unification in algorithm T

FIG. 3 is a flowchart of the process illustrated in FIG. 2.

FIG. 4 is a schematic view illustrating the coin transfer process, similarly to FIG. 2.

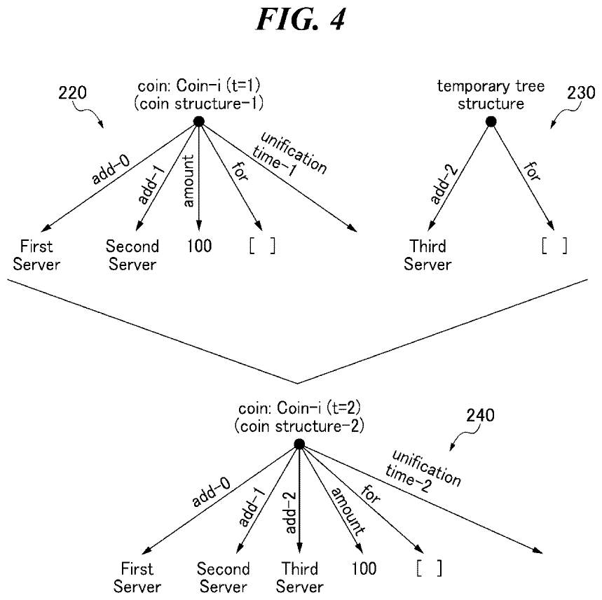

FIG. 5 is a schematic diagram showing an example of the unification process involving the addition of constraints.

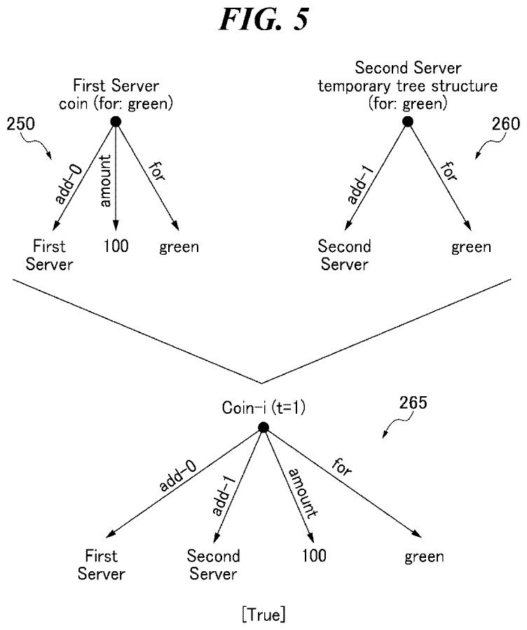

FIG. 6 is a schematic diagram showing an example of the unification process involving the addition of constraints.

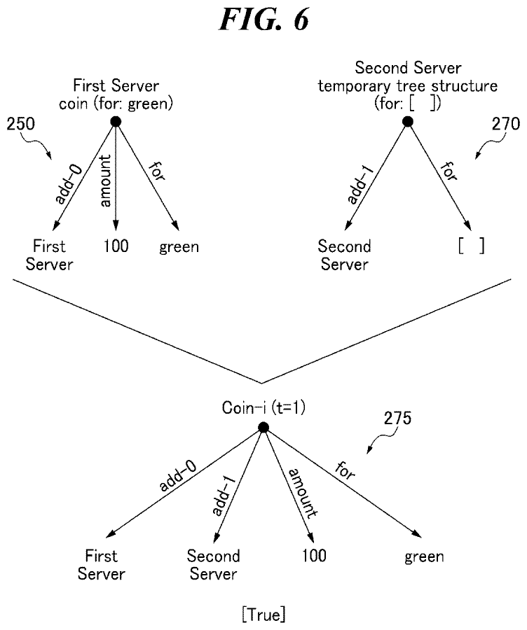

FIG. 7 is a schematic diagram showing an example of the unification process involving the addition of constraints.

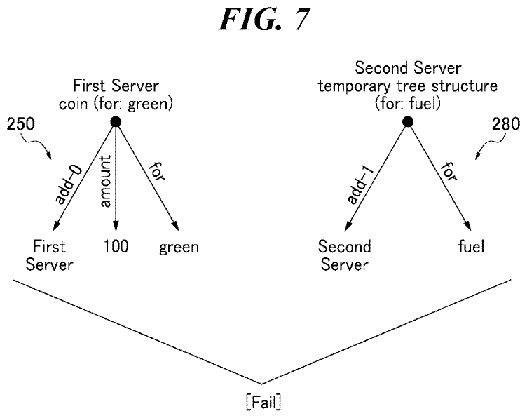

FIG. 8 is a block diagram of a cryptocurrency system in accordance with the first embodiment of the present invention.

FIG. 9 is a block diagram of an example of a cellular phone defining a second server in the cryptocurrency system illustrated in FIG. 8.

FIG. 10 is a flow-chart showing the operation of the cryptocurrency system illustrated in FIG. 8.

FIG. 11 is a flow-chart showing the operation of the cryptocurrency system in accordance with the second embodiment of the present invention.

FIG. 12 is a block diagram of a cryptocurrency system in accordance with the fourth embodiment of the present invention.

### DESCRIPTION OF THE EXEMPLARY EMBODIMENTS

Exemplary embodiments in accordance with the present invention will be explained hereinbelow with reference to drawings.

### First Exemplary Embodiment

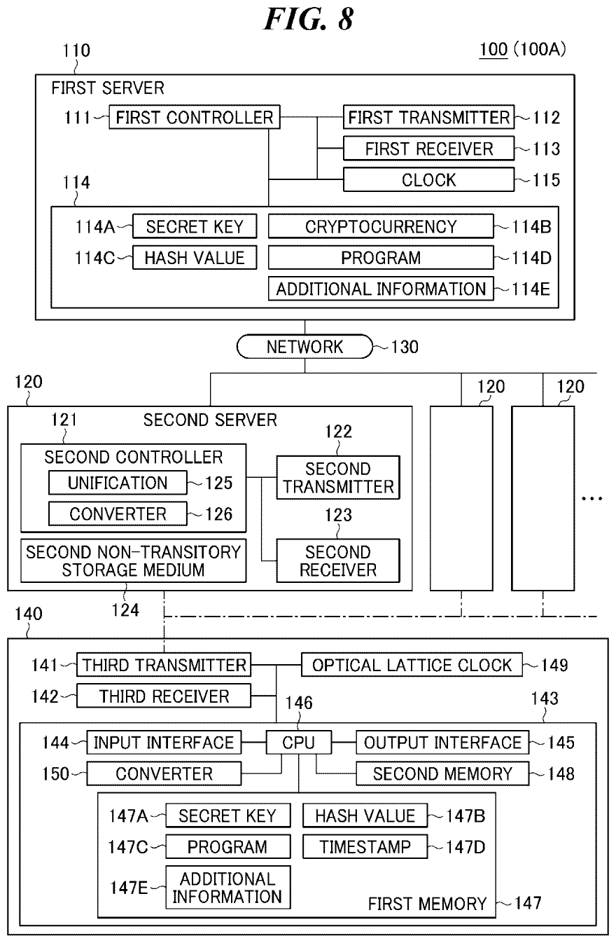

FIG. 8 is a block diagram of a cryptocurrency system 100 in accordance with the first exemplary embodiment of the present invention.

As illustrated in FIG. 8, the cryptocurrency system 100 includes a first server 110, a plurality of second servers 120, and a clock unit 140 independent of the first server 110 and the second server 120, and providing a timestamp.

The first server 110 includes a first controller 111 for controlling operation of the first server 110, a first transmitter 112 for transmitting signals and data to other servers, a first receiver 113 for receiving signals and data from other servers, a first non-transitory storage medium 114 storing therein a tree-structure defining a later-mentioned cryptocurrency 170, and a clock 115.

The first non-transitory storage medium 114 includes a secret-key storage area 114A for storing therein a secret key used for issuing a timestamp, a cryptocurrency storage area 114B for storing therein cryptocurrencies 170, a hash-value storage area 114C for storing therein hash values, a program storage area 114D storing therein various control programs (applications), and a additional-data storage area 114E for storing therein additional data necessary for the operation of the first controller 111.

The first server 110 and each of the second servers 120 are connected to each other through a network 130 (for instance, Internet).

Each of the second servers 120 includes a second controller 121, a second transmitter 122, a second receiver 123 and a second non-transitory storage medium 124.

The second controller 121 includes a unification unit 125 executing a unification process, and a converter 126 for converting data designated by a user into a hash value through a hash function (for instance, SHA-2 and SHA-3),

Each of the second servers 120 may be designed to be comprised of a cellular phone.

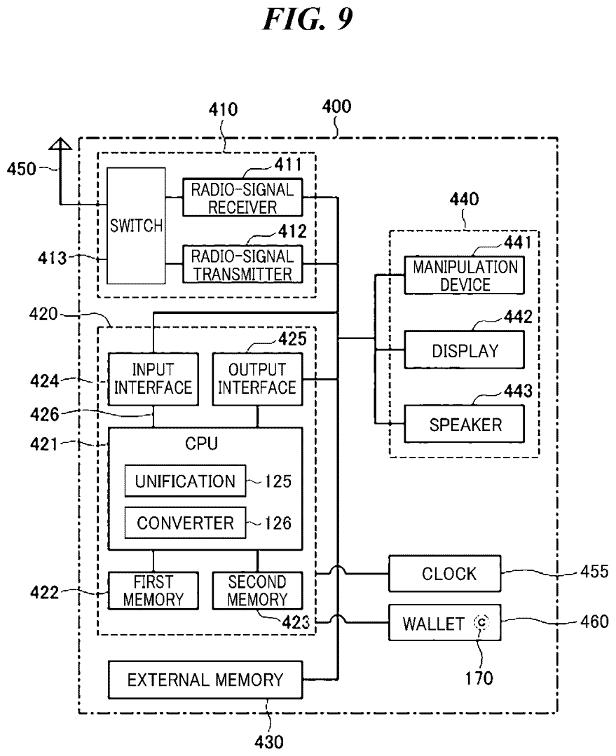

FIG. 9 is a block diagram illustrating an exemplary structure of a cellular phone 400 defining the second server 120.

The cellular phone 400 is designed to include, for instance, a communication unit 410, a control unit 420, an external memory 430, an input-output (IO) unit 440, an antenna 450, a buttery (not illustrated) providing electric power to those units, a clock 455, and a wallet 460.

The communication unit 410 is connected to the antenna 450, and transmits data to and receives data from other cellular phones in radio-signal communication.

The communication unit 410 includes a radio-signal receiver 411, a radio-signal transmitter 412, and switch 413.

The radio-signal receiver 411 demodulates data received from other cellular phones, and then, transmits the demodulated data to the control unit 420. The radio-signal transmitter 412 modulates data output from the control unit 420, and then, transmits the modulated data to other cellular phones through the antenna 450. The switch 413 receives an instruction signal output from the control unit 420, and exchanges a transmission mode to a receipt mode and vice versa in accordance with the received instruction signal.

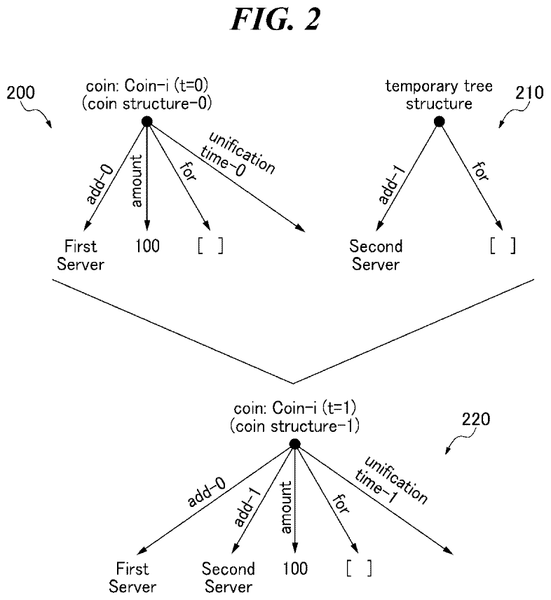

As illustrated in FIG. 2, the control unit 420 is comprised of a central processing unit (CPU) 421, a first memory 422 comprised of a read only memory (ROM), a second memory 423 comprised of a random access memory (RAM), an input interface 424 through which commands and/or data having been input into the control unit 420 are transmitted to the central processing unit 421, an output interface 425 through which results having been executed by the central processing unit 421 is output, and buses 426 through which the central processing unit 421 is electrically connected with the first memory 422, the second memory 423, the input interface 424, and the output interface 425.

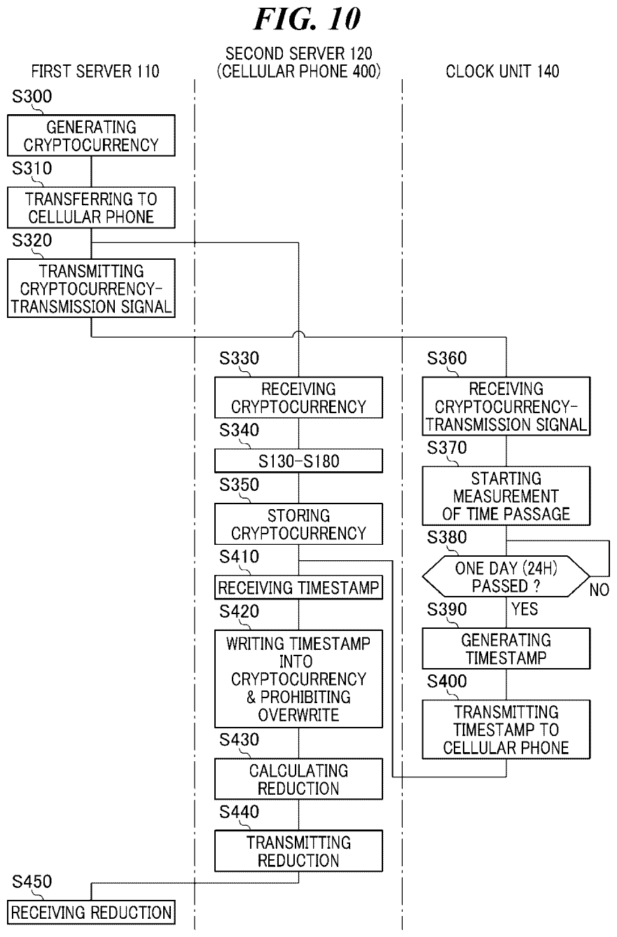

The first memory 422 stores therein both a program for causing the central processing unit 421 to execute the steps which will be explained with reference to FIG. 10, and unrewritable data.

Such a program may be presented through a non-transitory storage medium readable by a computer.

The second memory 423 stores therein various data and parameters, and presents a working area to the central processing unit 421. That is, the second memory 423 stores data temporarily necessary for the central processing unit 421 to execute the program.

The central processing unit 421 reads the program out of the first memory 422, and executes the program. Thus, the central processing unit 421 operates in accordance with the program stored in the first memory 422. In the present embodiment, the first memory 422 stores therein a program for executing the process shown in FIG. 10, that is, the process for causing each of the second servers 120 to return a reduced amount of the cryptocurrency 170 to the first server 110. The central processing unit 421 executes the steps shown in FIG. 10 in accordance with the program.

The central processing unit 421 includes the unification unit 125, and the converter 126 (see FIG. 8).

The timestamp transmitted from the clock unit 140 is stored in the second memory 423 or the external memory 430.

The IO unit 440 includes a manipulation device 441, a display 442, and a speaker 443.

The manipulation unit 441 is comprised of a ten-key pad, for instance. Various data is input into the cellular phone 400 through the manipulation unit 441.

The display 442 is comprised of a liquid crystal display (LCD), for instance. The display 442 displays computation results carried out by the control unit 420, and various data.

Audio data received from other cellular phones is output through the speaker 443.

The memory 430 works as an external memory for the control unit 140. Computation results carried out by the control unit 140 and various data are stored in the memory 430.

The wallet 460 is comprised of an application for storing therein the cryptocurrency 170 having been transmitted from the first server 110.

The first controller 111 of the first server has the same structure and functions as those of the control unit 420 of the cellular phone 400.

The first non-transitory storage medium 114 of the first server 110 stores in the cryptocurrency-storage area 114B data structures each defining the cryptocurrency 170. The first controller 111 transmits the cryptocurrency 170 to each of the cellular phones 400 through the first transmitter 112.

Similarly to the coin 200 illustrated in FIG. 2, the cryptocurrency 170 is comprised of a tree-structure, and is designed to have such a structure that an amount thereof reduces with the lapse of a certain period of time.

For instance, a half-life may be chosen as an algorism by which an amount of the cryptocurrency 170 is reduced. In physics, a half-life indicates a period of time in which a half amount of radioactive isotope (RI) is turned into another nuclide due to radioactive decay. The cryptocurrency 170 received in each of the cellular phones 400 is reduced in an amount to a half each time a half-life has passed.

The cryptocurrency 170 is transmitted to each of the cellular phones 400 from the first server 110, and is stored in the wallet 460.

As mentioned above, the cryptocurrency 170 is designed to reduce an amount thereof with passage of time. In the case that a half-life is chosen as an algorithm for the reduction in an amount of the cryptocurrency 170, assuming that a half-life is one year (365 days), a rate of today relative to tomorrow in of an amount of the cryptocurrency 170 is 365-th root of 2 (2^{1/365}):1. In other words, an amount of the cryptocurrency 170 is reduced at a rate of (2^{1/365}−1) day by day. For instance, the cryptocurrency 170 of 10,000 yen (JPY) is reduced next day to 9,981 yen, reduced a week later to 9,439 yen, reduced half a year later to 7,492 yen, reduced a year later to 5,000 yen, and reduced two years later to 2,500 yen.

The reduction in an amount of the cryptocurrency 170 in accordance with a half-life starts at the next day following a day of the issuance of the cryptocurrency 170. The issued cryptocurrencies 170 are reduced in an amount day by day in accordance with a half-life. Accordingly, the cryptocurrencies 170 having been received in the cellular phone 400 start being reduced at the next day following a day of the receipt of the cryptocurrencies 170.

The clock 455 is a timekeeping device pre-installed in the cellular phone 400. As described later, the control unit 420 writes the time measured by clock 455 into the tree structure defining the cryptocurrency 170 as an invisible timestamp at the moment when the unification process is successfully established.

The clock unit 140 includes a third transmitter 141 and a third receiver 142 both for communicating with the first server 110 through the network 130, a controller 143 that executes operations including creation of a timestamp, and an optical lattice clock 149 that provides time information to the controller 143.

The controller 143 includes an input interface 144, an output interface 145, a central processing unit (CPU) 146, a first memory 147, a second memory 148, and a converter 150 that converts predetermined data into hash values.

The controller 143 has a structure and functions similar to those of the control unit 420 in the cellular phone 400.

The first memory 147 stores various control programs to be executed by the CPU 146 as well as other non-rewritable data. Specifically, the first memory 147 includes a private key storage area 147A for storing a private key used in issuing timestamps, a hash value storage area 147B for storing hash values generated by the clock unit 140, a program storage area 147C for storing various control programs (applications), a timestamp storage area 147D for storing created timestamps, and an additional information storage area 147E for storing supplementary information necessary for the operation of the CPU 146.

A program that executes a method for creating timestamps (see later-mentioned FIG. 10) is stored in the program storage area 147C, and the clock unit 140 creates timestamps according to this program.

When the third receiver 142 receives a cryptocurrency-transmission signal from the first server 110, the third receiver 142 transmits the received signal to the optical lattice clock 149. The optical lattice clock 149 then sends the time at which the cryptocurrency-transmission signal was received, as reception-time information, to the CPU 146.

The optical lattice clock 149 has been selected for use because it currently possesses the highest level of precision among existing clocks.

The cryptocurrency system 100 having the structure as mentioned above operates as follows.

FIG. 10 is a flow-chart showing the steps to be carried out by the cryptocurrency system 100.

The first controller 111 of the first server 110 creates the cryptocurrency 170 (step S300 in FIG. 10), and stores the created cryptocurrency 170 into the cryptocurrency-storage area 114B.

The first server periodically transmits the cryptocurrency 170 to each of the cellular phones 400 (the second servers 120). For instance, the first server 110 transmits the cryptocurrency 170 once a week or a month to each of the cellular phones 400 (step S310 in FIG. 10).

The first controller 111, while transmitting the cryptocurrency 170 to the cellular phones 400, simultaneously sends a cryptocurrency-transmission signal indicating that the cryptocurrency 170 has been transmitted to the cellular phones 400, to the clock unit 140 (step S320 in FIG. 10).

The cryptocurrency 170 having been received in each of the cellular phones 400 is stored in the wallet 460 (the second non-transitory storage medium 124) (step S330 in FIG. 10).

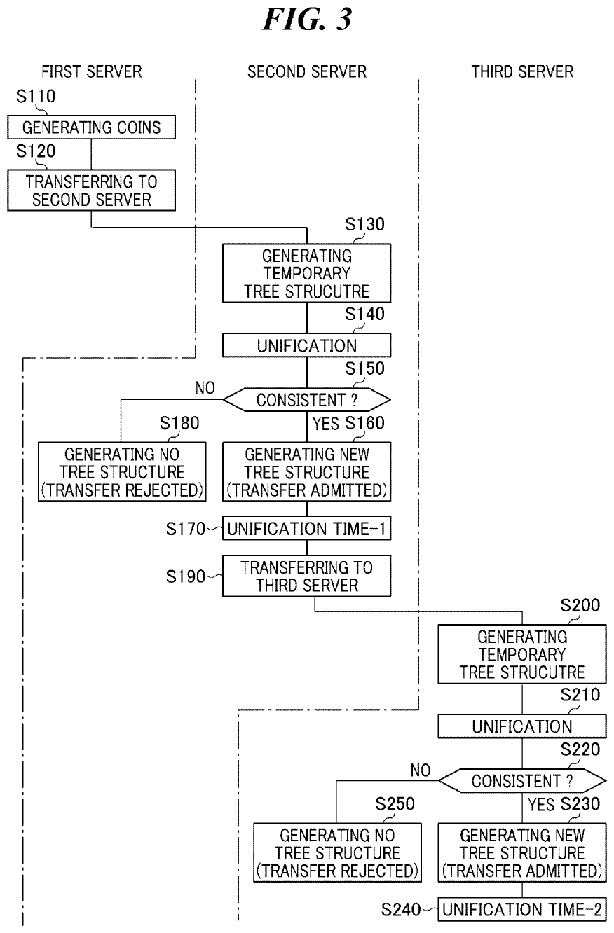

On receipt of the cryptocurrency 170 from the first server 110, the control unit 420 of each of the cellular phones 400 executes the steps S130 to S180 shown in FIG. 3 (step S340 in FIG. 10).

When unification is successfully established, the newly generated tree structure (corresponding to the tree structure 220 illustrated in FIG. 2) is stored in the wallet 460 as the cryptocurrency 170 having been transferred from the first server 110 (step S350 in FIG. 10).

When the clock unit 140 receives the cryptocurrency-transmission signal from the first server 110 (step S360 in FIG. 10), the control unit 143 activates the optical lattice clock 149 to thereby begin measuring the elapsed time, using the moment of receiving the cryptocurrency-transmission signal as a start time (step S370 in FIG. 10).

Based on the measurement results of the optical lattice clock 149, the control unit 143 judges whether one day (24 hours) has elapsed (step S380 in FIG. 10).

If one day (24 hours) has not yet elapsed since the reception of the cryptocurrency-transmission signal, the control unit 143 continues to repeat the judgment process until a day has passed (NO in step S380 of FIG. 10).

If one day (24 hours) has elapsed since the reception of the cryptocurrency transmission signal (YES in step S380 of FIG. 10), the control unit 143 converts information indicating that one day has passed since the transmission of the cryptocurrency 170 into a hash value through the converter 150, and combines this hash value with the time information to thereby generate a timestamp (step S390 in FIG. 10).

The thus generated timestamp is then transmitted to the cellular phones 400 (step S400 in FIG. 10).

On receipt of the timestamp (step S410 in FIG. 10), the control unit 420 of each of the cellular phones 400 writes the timestamp into the tree structure constituting the cryptocurrency 170, stores the timestamp in the external memory 430, and prohibits the external memory 430 to be overwritten (step S420 in FIG. 10).

As a result, the timestamp can no longer be overwritten.

Subsequently, the control unit 420 calculates a daily reduction amount of the cryptocurrency 170 (step S430 in FIG. 10).

The cryptocurrency is reduced in an amount in accordance with a half-life of one-year (365 days). Accordingly, a reduced amount D in one day is calculated in accordance with the following formula (A).

D=R×2^{1/365} (R: amount of the cryptocurrency 170) (A)

For instance, in the case that the first server 110 transmitted the cryptocurrency 170 having a value of 10,000 yen (JPY) to each of the cellular phones 400, the cryptocurrency 170 is reduced by 19 yen in a first day.

Consequently, when one day (24 hours) has passed from the receipt of the cryptocurrency 170 in each of the cellular phones 400, the cryptocurrency 170 having a value of 9,981 yen is included in the wallet 160.

10,000−19=9,981 yen

As an alternative, the cryptocurrency 170 is reduced by 561 yen in a first week (7 days).

Consequently, when one week (7 days) has passed from the receipt of the cryptocurrency 170 in each of the cellular phones 400, the cryptocurrency 170 having a value of 9,439 yen is included in the wallet 160.

10,000−561=9,439 yen

Subsequently, the control unit 420 of each of the cellular phones 400 is configured to read the time period (24 hours) written into the cryptocurrency 170. This time period corresponds to a predetermined time period during which a reduction amount of the cryptocurrency 170 is to be returned to the first server 110. The reception of the timestamp from the clock unit 140 serves as an indication that the predetermined time period has elapsed. Accordingly, the control unit 420 causes the first-day reduction amount of the cryptocurrency 170 to be transmitted to the first server 110 (step S440 in FIG. 10).

Upon receiving the reduction amount of the cryptocurrency 170, the first server 110 stores the received reduction amount in the cryptocurrency-storage area 114B provided within the first storage medium 114 (Step S450 in FIG. 10).

Thereafter, the aforementioned steps are repeatedly executed, whereby the reduction amount of the cryptocurrency 170 is successively returned from each of the cellular phones 400 to the first server 110 every 24 hours (i.e., once per day).

An owner of each of the cellular phones 400 can accomplish consumption activity such as purchase of goods through the cryptocurrency 170 he/she received from the first server 110. An amount of the cryptocurrency 170 stored in the wallet 460 is reduced by such consumption activity. In addition, even if an owner of each of the cellular phones 400 does not accomplish consumption activity, an amount of the cryptocurrency 170 stored in the wallet 460 in each of the cellular phones 400 is reduced with passage of days, as mentioned above.

The control unit 420 always monitors a residual amount of the cryptocurrency 170 stored in the wallet 460. When a residual amount of the cryptocurrency 170 goes below a predetermined threshold (for instance, 1,000 yen), the control unit 420 transmits a request signal to the first server 110 to request the first server 110 to additionally transmit the cryptocurrency 170. On the receipt of the request signal, the first server 110 makes the additional transmission of the cryptocurrency 170 (for instance, 10,000 yen) to the cellular phone 400 as well as the regular transmission of the cryptocurrency 170.

Thus, a residual amount of the cryptocurrency 170 stored in the wallet 460 is close to zero, the cryptocurrency 170 is additionally supplemented to the cellular phone 400 from the first server 110.

As an alternative, the first server 110 may be designed to periodically transmit a constant amount of the cryptocurrency 170 to each of the cellular phones 400. For instance, the first server 110 may be designed to transmit 30,000 yen once a week or transmit 100,000 yen once a month to each of the cellular phones 400.

In the cryptocurrency system 100, the passage of time is measured by means of the optical lattice clock 149 of the clock unit 140, and the measurement results are authenticated by the clock unit 140 through timestamps.

Although the passage of time may also be measured by means of the internal clock 455 built into each cellular phone 400, there is a risk that the clock 455 could be manipulated by a malicious user. For example, even if 24 hours have actually passed, the user could alter the clock 455 to make it appear as though only one hour has elapsed. By repeating this manipulation, the user could prevent or delay the return of the deducted portion of cryptocurrency 170.

In the cryptocurrency system 100, time authentication is performed by the clock unit 140 operating independently of each cellular phone 400, ensuring that such malicious user actions can be prevented.

Furthermore, in each of the cellular phones 400, overwriting of timestamps is prohibited to prevent tampering with the recorded time.

The cryptocurrency system operating in such a manner as mentioned above may be applied to a national economic policy. Hereinbelow is explained an economic policy to which the cryptocurrency system 100 is applied.

For instance, it is supposed that the first server 110 is a server of Bank of Japan, a central bank in Japan, and each of the cellular phones 400 is owned by each Japanese citizen.

Currency available in a present society is supposed not to decrease a value thereof, that is, supposed that a value thereof is preserved. Accordingly, wealthy people can save money, and can manage their money with an interest rate. Thus, their money is only partially introduced into a market, and resultingly, a market is not much stimulated, causing economy to be inactivated. In other words, only monetary economy is activated, but real economy is not activated.

However, it is possible to stimulate and thereby promote consumption activity by applying a character of “an amount thereof being reduced with passage of time” to the cryptocurrency 170.

As a result, in a trading area in which the cryptocurrency 170 designed to reduce in an amount in accordance with a half-life is used, currency (the cryptocurrency 170) is much circulated, and economic is stimulated, making a market richer as a whole. It is expected that a present society in which a wealthy people can be more wealthy is turned into a society in which all of people involved in a market can be wealthy.

In 2020, Bank of Japan issued about 120,000,000,000,000 yen (JPY) currency by quantitative easing (QE). These currencies are circulated to financial institution such as city banks.

In the economic policy to which the cryptocurrency system 100 is applied, the cryptocurrency 170 equal in an amount to the above-mentioned QE is distributed directly to national citizens as universal basic income (UBI). For instance, Bank of Japan (central bank in Japan) directly transmits a constant amount of currency (for instance, 200,000 yen) once a month to the wallet 160 of each of national citizens. This makes per a month credit creation calculated by the following formula.

200,000×number of national citizens

In view of national citizens, a policy of direct distribution of currency in place of purchase of national bonds from city banks will be highly supported. In the case that a reduction rate due to a half-life is greater than an interest rate, the cryptocurrency 170 will not be saved, and thus, consumption will be promoted and economic is stimulated, resulting in that a market, specifically real economy can be activated.

England Bank (central bank of United Kingdom) released that consumption activity by national citizens can be stimulated by carrying out buying operations directly to national citizens through legal currency (currency a value and an amount of which are not reduced), and thus, GDP increases by 3%. Thus, an advantage of encouragement of economic activity can be expected.

As mentioned above, consumption activity of national citizens is promoted by carrying out buying operations even through currency whose value and amount are not reduced. Since consumption activity is promoted also by the cryptocurrency 170 (currency whose amount is reduced with passage of time) in addition to the promotion of consumption activity by legal currency, GDP is expected to further increase.

The cryptocurrency 170 having a value of 200,000 yen distributed every month to national citizens by the universal basic income (UBI) policy is reduced day by day in accordance with a half-life. In the cryptocurrency system 100, a reduced amount of the cryptocurrency 170 is automatically transmitted back to the central bank (the first server 110) from all of the wallets 460. Thus, when a year as a half-life has passed, a half of the total amount of credit creation (200,000×number of national citizens per a month) is returned to the central bank.

TABLE 1
unit: 1,000,000,000,000 yen

| | 1st | 2nd | 3rd | 4th | 5th | 6th | 7th |
|---|---|---|---|---|---|---|---|
| | Year | Year | Year | Year | Year | Year | Year |
| UBI issuance | 240 | 240 | 240 | 240 | 240 | 240 | 240 |
| Collection | 0 | 120 | 180 | 210 | 225 | 233 | 237 |
| General Account | 0 | 120 | 120 | 120 | 120 | 120 | 120 |
| Surplus | 0 | 0 | 60 | 90 | 105 | 113 | 117 |

Table 1 shows a correlation among UBI issuance, collection, general account and surplus.

For instance, supposing that 2,000,000 yen is distributed to national citizens per a year, a total of 240,000,000,000,000 yen is annually created in the wallets 460 owned by 120,000,000 national citizens, and, as shown in Table 1, the central bank (the first server 110) receives 120,000,000,000,000 yen (180,000,000,000,000 yen or more two or more years later) a year later in the form of the cryptocurrency 170 from the wallets 460. By converting the returned cryptocurrency 170 into yen (JPY) as legal currency to thereby introduce into national treasury, it is possible to cover the annual general account (120,000,000,000,000 yen), resulting in creation of a tax-free country.

A reduced amount of the cryptocurrency 170 in accordance with a half-life can be substantially a tax. The current consumption tax system is dependent on consumption activity of consumers, and can be understood as penalty against consumption, including contradiction for national citizens to reduce consumption.

On the other hand, a tax (a reduced amount of the cryptocurrency 170) is automatically collected in the cryptocurrency system 100 in which an amount of the cryptocurrency 170 is reduced in accordance with a half-life, and accordingly, fiscal resources can be made stable. Since reduction in an amount of the cryptocurrency 170 in accordance with a half-life can be understood as penalty against no consumption, it is possible to expect promotion of consumption by national citizens.

It is possible to stop the reduction in an amount of the cryptocurrency 170 having been collected to the central bank (the first server 110) from national citizens (the cellular phones 400). That is, it is possible to design not to reduce a collected amount of the cryptocurrency 170. By so designing the cryptocurrency 170, the central bank or the nation is able to spend the collected cryptocurrency 170 without reduction thereof. For instance, it is possible to cover a general account with the collected cryptocurrency 170, and if surplus is generated, the surplus may be delivered to foreign countries, in which case, inflation is not caused in Japan. It is possible to accomplish foreign aid such as ODA (Official Development Assistance) or purchase US treasury notes, EU bonds or Chinese government bonds.

In a society in which conventional currency (legal currency) a value and an amount of which are not reduced with passage of time is available, wealthy people can manage their money with an interest of rate to thereby acquire more money. Their money is not circulated in a market, and accordingly, a market is not stimulated. Laborers in a society in which economy is not good cannot afford to save money. Thus, a difference between the poverty and the wealth tends to be increased.

In contrast, in a society in which the cryptocurrency 170 an amount of which is designed to be reduced in accordance with a half-life is introduced, consumption activity is promoted and economy is stimulated, resulting in that a benefit is provided to those involved in a market. In other words, a switch to the cryptocurrency 170 from current legal currency may be a big turning point at which a society having low abstraction of “a priority is given to individual benefit” is turned into a society having high abstraction of “a priority is given to all”.

Universal basic income (UBI) making use of the cryptocurrency 170 an amount of which is reduced in accordance with a half-life is characterized in that the cryptocurrency 170 can be directly transmitted into each of the wallets 160, and that UBI has a purpose of promoting consumption activity. To this end, it is possible to prohibit to exchange the cryptocurrency 170 to legal currencies such as Japanese yen (JPY) and US dollar (USD), and to purchase financial products such as securities and precious metals for saving money. It is basically supposed that the cryptocurrency 170 is used for purchasing consumables, foods daily necessities and cloths, paying public utility charges of lifeline and house rent, or compensating for travel fees.

It is possible to prohibit to exchange the cryptocurrency 170 to legal currencies and purchase financial products by introducing a prohibition rule into a program defining the cryptocurrency 170. Purchase of products by using the cryptocurrency 170 is accomplished through the network 130. When the program determines that products to be purchased are financial products for saving money, the program does not allow to continue the purchase process, and terminates the purchase.

Silvio Gesell (1862-1930), a German economist and businessman, questioned a present society in which an interest rate is justified because only currency is not reduced in a value although everything is reduced in a value, and thus, the wealthy can live by virtue of an interest rate without working so hard. In order to solve this problem, he suggested the concept of free money in his book “The Natural Economic Order”.

The free money is allowed to use on condition that a predetermined amount of a stamp should be periodically (for instance, per a week or per a month) attached to a bill. The free money has a purpose of preventing currency from being into dead storage, promoting circulation of currency, and decreasing an interest of rate. This is just reduction of currency in a value, and is essentially different from reduction of currency in an amount in the cryptocurrency 170.

As mentioned above, the cryptocurrency system 100 in accordance with the first embodiment can be a base of a policy useful to a society, and is potential for solving current economic problems.

It should be noted that the cryptocurrency system 100 in accordance with the first embodiment is not to be limited to the above-mentioned structure, but has many various options.

Though the cryptocurrency system 100 is designed to include a single first server 110, the cryptocurrency system 100 may be designed to include two or more first servers 110.

For instance, in the case that the cryptocurrency system 100 is designed to include two first servers 110, one of the first servers 110 may be designed to deal with the cryptocurrency 170 an amount of which is reduced in accordance with a half-life, and the other may be designed to deal with cryptocurrencies mentioned in later-mentioned second and third embodiments.

The second servers 120 in the cryptocurrency system 100 are designed to comprise a cellular phone 400. As an alternative, the second servers 120 may be designed to comprise a personal computer, a tablet or a mobile device designed only for receiving a cryptocurrency.

The cryptocurrency 170 is designed to be reduced in an amount to a half per a year (365 days). It should be noted that an administrator (the currency issuer) of the first server 110 may choose any algorithm for determining a rate at which an amount of the cryptocurrency 170 is reduced.

An administrator (Bank of Japan or the issuer of the cryptocurrency 170) may design that the cryptocurrency 170 having been returned to the first server 110 from the cellular phone 400 is not reduced in an amount.

The cryptocurrency 170 in the cryptocurrency system 100 is designed to be reduced in an amount with the passage of time. The cryptocurrency 170 may be designed to be reduced in both an amount and a value with the passage of time. For instance, the cryptocurrency 170 may be designed to be reduced in an amount to a half, and further, in a value to a half when a half-life has passed.

In the above-mentioned case, it is not necessary to set a speed at which the cryptocurrency 170 is reduced in an amount equal to a speed at which the cryptocurrency 170 is reduced in a value. Those speeds may be different from each other. For instance, a half-life may be chosen as a speed at which the cryptocurrency 170 is reduced in an amount, and other factor (for instance, a price increase rate, a percentage change of GDP, a percentage change of annual average income) may be chosen as a speed at which the cryptocurrency 170 is reduced in a value.

The first server 110 transmits a cryptocurrency-transmission signal to the clock unit 140 (step S320 in FIG. 10). At this time, the first server 110 may also transmit to the clock unit 140 a hash value of type information indicating a type of cryptocurrency (e.g., BTC, ETH, USDT, etc.).

The clock unit 140 generates a timestamp including the hash value of the type information, and transmits this timestamp to the cellular phones 400 (step S400 in FIG. 10).

When the first server 110 transmits a plurality of types of cryptocurrencies 170 to the cellular phones 400, the timestamp written into the tree structure includes the type information, thereby preventing a wrong type of cryptocurrency 170 from being transmitted to the cellular phones 400.

Furthermore, when the control unit 420 has accumulated a predetermined number of timestamps having been transmitted from the clock unit 140 over a predetermined period (for example, one week), the control unit 420 may convert these timestamps into hash values by means of the converter 126 and transmit the resulting hash values to the clock unit 140.

Upon receiving the hash values of the timestamps, the clock unit 140 may further convert them into new hash values, and transmit the new hash values to the cellular phones 400.

By performing such re-hashing, it is possible to more securely prevent time data from being tampered.

The rate of reduction of the cryptocurrency 170 does not necessarily need to be constant, and the rate may be varied in association with other factors as required.

For example, the rate may be varied in accordance with national indicators such as an inflation rate or an unemployment rate. When an inflation rate is positive (indicating rising prices), the value-reduction rate may be lowered, and when an inflation rate is negative (indicating falling prices), the value-reduction rate may be increased.

### Second Exemplary Embodiment

A cryptocurrency system 100A in accordance with the second exemplary embodiment has the same structure as that of the cryptocurrency system 100 in accordance with the first exemplary embodiment. Thus, FIG. 8 is used as a block diagram of the cryptocurrency system 100A.

However, the cryptocurrency system 100A operates differently from the cryptocurrency system 100.

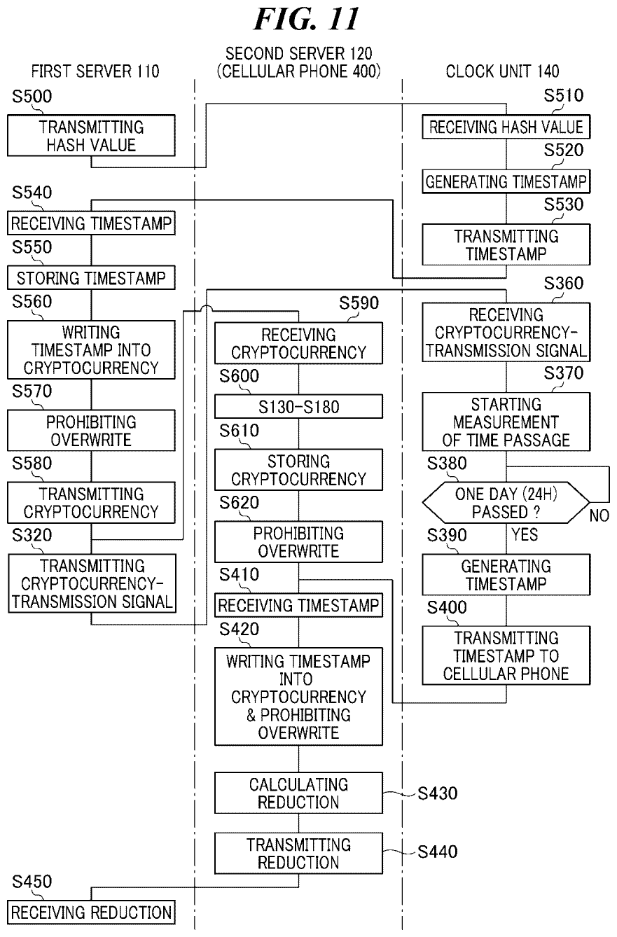

FIG. 11 is a flowchart showing the operation of the cryptocurrency system 100A.

Similarly to the first embodiment, a reduced portion of the cryptocurrency 170 is transmitted back to the first server 110 from each of the cellular phones 400 each time one day (24 hours) has passed.

The first controller 111 converts, by means of the converter 116, information indicating a period of one day (24 hours), which is a predetermined period of time serving as the reduction period of the cryptocurrency 170, into a hash value, and transmits the hash value to the clock unit 140 (step S500 in FIG. 11).

Upon receiving the hash value (step S510 in FIG. 11), the clock unit 140 generates a timestamp including the integration of the hash value with time information (step S520 in FIG. 10).

The thus generated timestamp is transmitted to the first server 110 (step S530 in FIG. 11).

After receiving the timestamp (step S540 in FIG. 11), the first controller 111 stores the received timestamp in the timestamp-storage area 114E of the first non-transitory storage medium 114 (step S550 in FIG. 11), and writes the timestamp into the cryptocurrency 170 as a part of the data structure thereof (step S560 in FIG. 11).

Furthermore, the first controller 111 sets a write-prohibition condition for the cryptocurrency 170 (step S570 in FIG. 11). That is, the timestamps are allowed only to be sequentially added to the cryptocurrency 170. Accordingly, the timestamp once written into the cryptocurrency 170 cannot be tampered.

Subsequently, the first controller 111 transmits the cryptocurrency 170 to each of the cellular phones 400 (step S580 in FIG. 11).

When the control unit 420 of each of the cellular phones 400 receives the cryptocurrency 170 from the first server 110 (step S590 in FIG. 11), the control unit 420 executes the steps S130 to S180 shown in FIG. 3 through the unification unit 125 (step S600 in FIG. 11).

When unification is successfully established, a newly generated tree structure (for example, the tree structure 220 shown in FIG. 2) is stored in the wallet 460 (step S610 in FIG. 11), and the control unit 420 prohibits the wallet 460 to be overwritten (step S620 in FIG. 11).

The first controller 111 transmits the cryptocurrency 170 to each of the cellular phones 400, and simultaneously, transmits a cryptocurrency-transmission signal, indicating that the cryptocurrency 170 has been transmitted to each of the cellular phones 400, to the clock unit 140 (step S320 in FIG. 10).

Upon receiving the cryptocurrency-transmission signal, the clock unit 140 performs the steps S360 to S400 as shown in FIG. 10.

Thereafter, the steps S410 to S440 shown in FIG. 3 are executed in each of the cellular phones 400, and then, the step S450 shown in FIG. 3 is executed in the first server 110.

The cryptocurrency system 100A according to the second embodiment can provide the same advantages as those of the cryptocurrency system 100 according to the first embodiment.

### Third Exemplary Embodiment

With respect to an automobile, for instance, there is a remarkable difference in a selling price between Japanese standard cars and Italian sporty cars, though there is no difference in costs of raw materials (physical value). Accordingly, it is considered that a factor by which a big difference in a selling price is caused comprises informational value such as power of brand and/or design. In view of this sample case, it is considered that a price consists of a sum of physical value and informational value.

Prices of most of daily necessities surely include informational value. Consequently, if physical value and informational value can be separated from each other, prices of most of daily necessities can be significantly reduced. That is, it is possible to set the prices close to physical value.

Informational value includes socially useful services provided by corporate activities as well as brand and/or design.

For instance, railway companies in Japan provide a value of service that trains are managed to run just in accordance with a time table. Home delivery companies provide a value of service that goods are safely delivered to a designated place at a designated time.

It is possible to issue a cryptocurrency where the informational value of services caused by such company activities acts as a security. In other words, it is possible to issue a cryptocurrency based on the informational value including a service by the name of “information cryptocurrency”, for instance.

In the cryptocurrency system in accordance with the third embodiment, a cryptocurrency 171 is used in place of the cryptocurrency 170 used in the first exemplary embodiment. The cryptocurrency 171 is characterized in that an amount thereof is reduced to a half when a half-life has passed, similarly to the cryptocurrency 170, and that the cryptocurrency 171 is based on such informational value as mentioned above.

The second server 120 in the present cryptocurrency system is administrated by a railway company, for instance. The railway company provides a society a value of service that trains run in accordance with a time table. Activity of managing trains to run in accordance with a time table has immaterial value. Thus, a central bank (a nation or a financial institution corresponding to a central bank) administrating the first server 110 newly issues a cryptocurrency 171 by the name of “railway cryptocurrency”, for instance, and loans the cryptocurrency 171 to the railway company, that is, newly makes creation of credit to the railway company.

In a standpoint of the railway company, the railway company can acquire funds not necessary to return, similarly to funds acquired by issue of stocks, and further, strengthen railway activities by virtue of the thus acquired funds.

Hereinbelow is explained an example of the above-mentioned information cryptocurrency.

The inventor of the present invention has started the operation of “coaching coin” which is one of information cryptocurrencies and deals with coaching knowledge, at the end of 2021, as demonstration experiment of information cryptocurrency. About 200 persons have acquired the coaching coin by October in 2022. The coaching coins have been issued to about 20,000 coaching knowledge by now. The coaching coins are issued by the coaching coin bank (the coaching coin bureau) corresponding to a central bank.

Coaching activities to which the coaching coin is to be issued and an amount of issuance of the coaching coin may be determined by the bureau or weighted direct election by users.

For instance, the coaching coin is issued to attending to coaching seminar, joining sessions, and purchasing books, moving pictures or DVD.

An amount of issuance of the coaching coin is about 3% of the coins owned by a coach in the case of attending to a session, 3 coins per a book, and 6 coins per attending to a seminar, for instance.

### Fourth Exemplary Embodiment

In the cryptocurrency system 100 in accordance with the first exemplary embodiment, the cryptocurrency 170 is unconditionally transmitted to the second servers 120 from the first server 110. The first server 110 may be designed to conditionally transmit the cryptocurrency 170 to the second servers 120. That is, the first server 110 may be designed to transmit the cryptocurrency 170 to the second servers 120 only when an owner of each of the second servers 120 meets a predetermined condition or requirement.

As mentioned earlier, in algorithm T, the constraint(s) may be embedded directly into a tree structure defining the coin

In the cryptocurrency system 300 in accordance with the third exemplary embodiment, as shown in the later-mentioned examples, the first server 110 transmits the cryptocurrency to the second servers 120 only when an owner of each of the second servers 120 meets a predetermined condition or requirement.

The cryptocurrency 171 having been mentioned in the third exemplary embodiment can be considered to be provided only when an owner of each of the second servers 120 meets a predetermined condition or requirement, that is, a condition that a railway company, an owner of the second server 120, operates a railroad in accordance with a timetable.

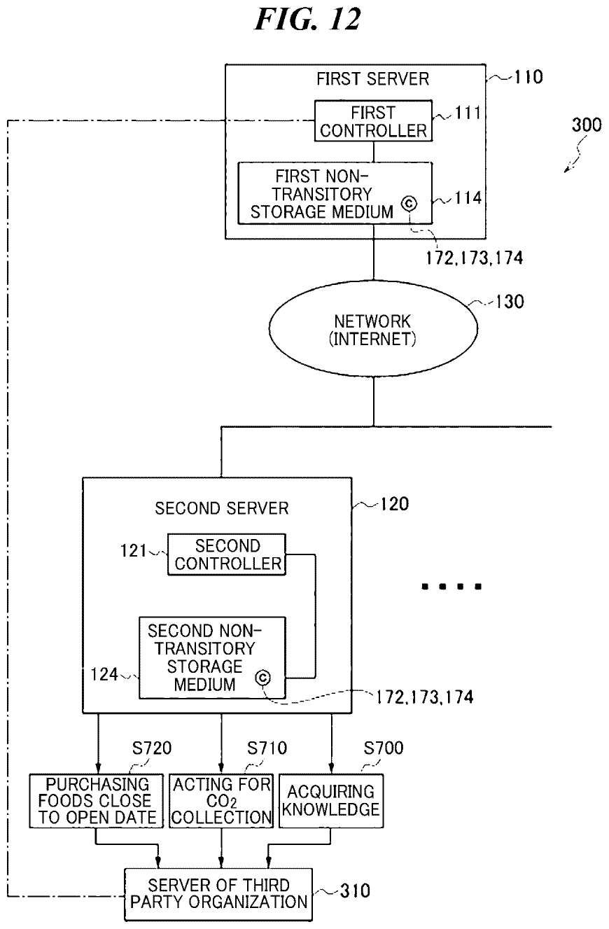

FIG. 12 is a block diagram of a system cryptocurrency 300 in accordance with the third exemplary embodiment.

As illustrated in FIG. 12, the cryptocurrency system 300 is designed to additionally include a server 310 of a third party in comparison with the cryptocurrency system 100.

When an owner of the second server 120 meets a condition or requirement predetermined by a third party of an administrator or the first server 110, the server 310 transmits a signal indicative of the accomplishment of a predetermined condition or requirement to the first server 110. On receipt of the signal, the control unit 111 of the first server 110 transmits later-mentioned cryptocurrency 172, 173 or 174 to the second server 120. The cryptocurrencies 172, 173 and 174 are identical with the cryptocurrency 170, but are distinguished from the cryptocurrency 170, because the cryptocurrencies 172, 173 and 174 are issued with a condition different from the condition with which the cryptocurrency 170 is issued.

The first server 110 in the third exemplary embodiment may be administrated by a country (a national bank) or a financial institution such as a bank managed by a third party. The first server 110 not only in the current exemplary embodiment, but also other exemplary embodiments may be administrated by an individual or a juridical person as well as a nation. For instance, a juridical person doing a business (for instance, the organization issuing the above-mentioned coaching coins) can issue various cryptocurrencies 170 to 174 as an administrator of the first server 110 with respect to his/her business.

Hereinbelow are explained examples of a condition or requirement to be satisfied by an owner of the second server 120.

### First Example

In a current society, everyone needs to pay much school expenses in order to receive higher education. Accordingly, there is caused a social problem that a lot of persons cannot pay school expenses and thus cannot have an opportunity of the learning. This problem can be solved by a cryptocurrency.

The first example of a condition or requirement which an owner of the second server 120 needs to meet is that an owner of the second server 120 acquires certain knowledge.

When an owner of the second server 120 acquires knowledge from a third party (step S700 in FIG. 12), for instance, when an owner of the second server 120 attends to a lesson (including a lesson of music or art and exercise of sport) in a third party organization or when purchases teaching materials such as a book from a third party organization, the server 310 of the third party organization so notifies the first server 110. Then, the first server 110 pays a cryptocurrency 172 (by the name of “knowledge coin”, for instance) to the second server 120 in accordance with a time of the lesson, a difficulty of the lesson, a price of the book, or a number of pages of the book. An amount of the cryptocurrency 172 to be paid may be determined by an administrator of the first server 110.

An owner of the second server 120 can acquire new knowledge through the use of the thus acquired cryptocurrency 172. For instance, he/she can attend to other lessons or newly purchase teaching materials in a block of the cryptocurrency 172, and thus, can newly acquire the cryptocurrency 172. That is, more and more he/she acquires knowledge, he/she can acquire a higher amount of the cryptocurrency 172.

As mentioned above, the first example accomplishes a system in which a person who wants to study can study so much.

For instance, children in Japan acquire much knowledge in both an elementary school and a junior high school in compulsory education system, and hence, Japan government (the first server 110) may transmit the cryptocurrency 172 to children for acquisition of the knowledge. Children having acquired the cryptocurrency 712 can enter a high school and a university, resulting in that a society in which persons who want to study can study so much can be realized.

### Second Example

It is currently required to reduce carbon dioxide (CO₂) emission because CO₂ causes anathermal of the earth. This problem can be solved through the use of cryptocurrency.

For instance, when an owner of the second server 120 purchases an apparatus from a third party organization for collecting CO₂ or voluntarily acts for collection of CO₂ in a third party organization (step S710 in FIG. 12), the server 310 so notifies the first server 110, and then, the first server 110 pays cryptocurrency 173 (by the name of “CO₂ coin”, for instance) to the second server 120 in accordance with a number of the purchased CO₂ collection apparatuses or a time of the voluntary action.

An object of the second example is to realize a society in which the cryptocurrency 173 has to be paid as well as purchase price (legal currency) in order to buy products which emit much CO₂ when fabricated.

In such a society, for instance, when you buy a cup of coffee in a convenience store, you have to pay not only 100 yen (JPY: legal currency) as a price of a cup of coffee, but also the cryptocurrency 173 corresponding to CO₂ emission having been caused by transportation of coffee beans, fabrication of a coffee cup, boiling water and so on.

Some countries are currently carrying out a policy for reducing CO₂ such as dealing of a right to emit CO₂ or carbon tax. However, such a policy can be rephrased “you are allowed to emit CO₂, if you pay money (tax) accordingly”. That is, it can be said that the policy admits emission of CO₂, and thus, the policy cannot be considered to be direct action for reducing CO₂.

Since the cryptocurrency 173 is given only to actions to be carried out to realize a sustainable society aiming at reduction of CO₂, purchasing the cryptocurrency 173 can be direct action leading to reduction of CO₂.

### Third Example

One of worldwide problems is shortage of foods. The cryptocurrency is effective to the problem.

For instance, when an owner of the second server 120 purchases foods close to an open date (or expiration date) from a third party organization (food shop) (step S720 in FIG. 12), the server 310 of the third party organization notifies the first server 110 of the purchase by the owner, and then, the first server 110 pays the cryptocurrency 174 (by the name of “food loss coin”, for instance) to the second server 120 in accordance with days to the open date. A greater amount of the cryptocurrency 174 is paid to the second server 120 with the shorter days to the open date.

This third example provides one of aids to solve a food loss problem, that is, a problem that a food an open date of which expires is disposed.

An owner of the second server 120 can newly purchase foods through the use of the thus acquired cryptocurrency 174. Thus, there is realized a system in which a person who acts for contribution to reduction of food loss can newly acquire foods. Herein, it is not necessary to use conventional legal currency.

As mentioned earlier, as a general rule, it is prohibited to exchange the cryptocurrency 170 to other cryptocurrencies. However, as an exception, it is possible to design the cryptocurrencies 170 to 174 in the first to third exemplary embodiments to be exchangable to one another.

For instance, the cryptocurrency 172 obtained by acquiring knowledge is designed to be exchangable to the food loss coin 174, in which case, any person can obtain the cryptocurrency 172 by studying any subjects, exchange the thus obtained cryptocurrency 172 to the food loss coin 174, and acquire foods through the use of the food loss coin 174.

One of current social problems is that poor children in developing countries are driven to work, and accordingly, cannot go to school to thereby fail to receive education. This enlarges education inequality. In accordance with the third example, study is directly linked to foods, providing one of aids to solve educational inequality.

### Fifth Exemplary Embodiment

Physically spatial value can be grasped as inherent information, and this inherent information can be valued through a cryptocurrency.

For instance, a country having rare metals under the ground can be said to have informational value of “resources exist under the ground”, even if those resources are not yet excavated. The country can turn the informational vale to non-fungible token (NFT) to thereby issue a cryptocurrency 175 (by the name of “NFT coin”, for instance). That is, the cryptocurrency 175 is based on non-excavated resources as a security. For instance, NFT can be issued for every weight unit (pound or kilogram) of non-excavated resources.

Since it is not necessary for the country to directly excavate resources, it is possible to avoid the resources from actually giving them to existing economic giants. A cryptocurrency system for accomplishing the fifth embodiment may be comprised of the cryptocurrency system 100 in accordance with the first embodiment.

In the fifth embodiment, the first server 110 is administrated by a government of a nation having rare metal resources, and the sever servers 120 are owned by persons who purchased the NFT coin 175.

For instance, the administrator of the first server 110, that is, a government of a nation having rare metal resources may mine rare metal resources only when a market price of the NFT coin 175 goes below a predetermined price. Thus, it is possible to continuously and stably run economy. If money exchange rate can be kept stable, it would not be necessary to mine underground resources.

The exemplary advantages obtained by the above-mentioned exemplary embodiments are described hereinbelow.

The cryptocurrency system accordance with the above-mentioned exemplary embodiments can be applied to a national economic policy, and further, can provide economic serviceability to a society.

For instance, it is supposed that the first server is administrated by Bank of Japan, that is, a central bank in Japan, the second servers are owned by Japanese people, and data transmitted to the second servers from the first server constitutes cryptocurrency. A predetermined amount of the cryptocurrency is transmitted to all Japanese people every month (or every week) from Bank of Japan. Japanese people can cover their living expenses with this cryptocurrency, and further, can make various consumption activities, activating real economy in Japan. The cryptocurrency transmitted from the first server is designed to reduce in an amount day by day. A reduced amount of the cryptocurrency is returned to the first server. Japan government can cover general account with the cryptocurrency having returned back to the first server, resulting in that a no-tax nation can be formally realized.

While the present invention has been described in connection with certain exemplary embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2022-176461 filed on Nov. 2, 2022 including specification, claims, drawings and summary is incorporated herein by reference in its entirety.

What is claimed is:

1. A cryptocurrency system making use of unification type data structure guaranteeing monotonicity, including:
a first server including a first controller, a first communication unit, and a first non-transitory storage medium; and
a second server including a second controller, a second communication unit, and a second non-transitory storage medium,
wherein
the second controller includes a unification unit carrying out unification process,
the first controller generates cryptocurrency comprised of tree-structured data having an attribute,
the second controller, when the second server receives the cryptocurrency from the first server, makes in the second non-transitory storage medium a temporary tree-structure of cryptocurrency candidate to be received from the first sever,
the unification unit carries out the unification process to compare the attribute of the cryptocurrency having been generated by the first controller to the attribute of the candidate cryptocurrency, and
the unification unit generates a new tree-structure only when both of the attributes logically match each other, and does not generate a new tree-structure when both of the attributes do not logically match each other.

2. The cryptocurrency system as set forth in claim 1, wherein when another second server receives the cryptocurrency from the second server, the second controller of the another second server makes in the second non-transitory storage medium a temporary tree-structure of cryptocurrency candidate to be received from the second sever,
the unification unit carries out the unification process to compare the attribute of the cryptocurrency of the second controller to the attribute of the candidate cryptocurrency, and
the unification unit generates a new tree-structure only when both of the attributes logically match each other, and does not generate a new tree-structure when both of the attributes do not logically match each other.

3. The cryptocurrency system as set forth in claim 1, wherein restriction and/or purpose for using the cryptocurrency are (is) written into the tree-structured data.

4. The cryptocurrency system as set forth in claim 1, wherein the first server further includes a clock, and
the first controller writes a generation time into the tree-structured data,
the generation time being defined as a time at which the first controller generated the cryptocurrency, and being measured by the clock.

5. A cryptocurrency system making use of unification type data structure guaranteeing monotonicity, including:
a first server including a first controller, a first communication unit, and a first non-transitory storage medium;
a second server including a second controller, a second communication unit, and a second non-transitory storage medium; and
a clock unit independent of the first and second servers,
wherein
the second controller includes a unification unit carrying out unification process,
the first controller generates cryptocurrency comprised of tree-structured data having an attribute, and transmits the cryptocurrency to the second server,
the second controller, when the second server receives the cryptocurrency from the first server, makes in the second non-transitory storage medium a temporary tree-structure of cryptocurrency candidate to be received from the first sever,
the unification unit carries out the unification process to compare the attribute of the cryptocurrency having been generated by the first controller to the attribute of the candidate cryptocurrency,
the unification unit generates a new tree-structure only when both of the attributes logically match each other, and does not generate a new tree-structure when both of the attributes do not logically match each other,
the cryptocurrency is designed to have such a structure that at least amount among value and amount thereof is reduced with passage of a predetermined period of time,
the clock unit transmits hashed time data to the second server every predetermined period of time,
the second controller writes the hashed time data into the cryptocurrency, and prohibits the hashed time data to be overwritten, and
the second controller transmits a reduced amount of the cryptocurrency to the first sever at the passage of the predetermined period of time having written into the cryptocurrency.

6. The system as set forth in claim 5, wherein when another second server receives the cryptocurrency from the second server, the second controller of the another second server makes in the second non-transitory storage medium thereof a temporary tree-structure of cryptocurrency candidate to be received from the second sever,
the unification unit of the another second server carries out the unification process to compare the attribute of the cryptocurrency of the second server to the attribute of the candidate cryptocurrency, and
the unification unit generates a new tree-structure only when both of the attributes logically match each other, and does not generate a new tree-structure when both of the attributes do not logically match each other.

7. The cryptocurrency system as set forth in claim 5, wherein restriction and/or purpose for using the cryptocurrency are (is) written into the tree-structured data.

8. The cryptocurrency system as set forth in claim 5, wherein the clock unit converts kind data indicative of a kind of the cryptocurrency as well as the time data into a hash value, and transmits the hash value to the second server.

9. The cryptocurrency system as set forth in claim 5, wherein the second controller, when the time data is accumulated in an amount in a predetermined period, converts the accumulated time data into a hash value.

10. The cryptocurrency system as set forth in claim 5, wherein the first controller a reduction rate of the cryptocurrency in accordance with a predetermined index.

11. The cryptocurrency system as set forth in claim 5, wherein the second server comprises a cellular phone or a portable computer.

12. The cryptocurrency system as set forth in claim 5, wherein the predetermined period of time is a half-life, the cryptocurrency being reduced in an amount to a half when the half-life has passed.

13. The cryptocurrency system as set forth in claim 5, wherein the first server is owned by a national government of a certain nation, and the second server is owned by people of the certain nation.
